(19) United States
(12) Patent Application Publication
(10) Pub. No.: US 2007/0006051 A1
(43) Pub. Date: Jan. 4, 2007

(54) Fault diagnosis for power switch using existing current sense outputs

(75) Inventors: Gary J. Burlak, Lake Orion, MI (US); Marian Mirowski, West Bloomfield, MI (US)

Correspondence Address: Lisa K. Jorgenson, Esq.;STMicroelectronics, Inc., 1310 Electronics Drive, Carrollton, TX, 75006, US

(73) Assignee: STMicroelectronics, Inc., Carrollton, TX (US)

(21) Appl. No.: 11/170,882

(22) Filed: Jun. 30, 2005

(51) Int. Cl. G06F 11/00

(52) U.S. Cl. 714/47

(57) ABSTRACT

Existing current sense outputs in a power switch can be utilized to output fault diagnosis information. Current sense circuitry that normally drives the current sense output can be disabled, thereby permitting the fault diagnosis information to be output. An existing fault indicator output can be controlled for bidirectional operation, thereby permitting an external controller to control the output of fault diagnosis information on the existing current sense output.

### TECHNICAL FIELD OF THE INVENTION

The invention relates generally to power switches and, more particularly, to fault diagnosis in power switches.

### BACKGROUND OF THE INVENTION

Power switches have a wide variety of applications. Examples of such applications are driving electromechanical devices such as valves, solenoids, relays, actuators and positioners. Other examples include driving thermal devices such as heaters, coolers and lamps. Many of these applications can be found in automobiles.

Power switches are conventionally provided with fault diagnostic capabilities. For example, a conventional power switch may be capable of detecting faults such as short circuit and other overcurrent conditions, excessive temperature conditions, etc. The power switch typically includes dedicated facilities for providing fault diagnosis information to an external controller. For example, some conventional power switches include a serial interface such as an SPI interface for providing the fault diagnosis information. Other conventional power switches may include a plurality of dedicated pins for providing digital code outputs indicative of the detected faults.

It is desirable in view of the foregoing to provide for outputting fault diagnosis information from a power switch without requiring dedicated facilities for such fault diagnosis output.

### SUMMARY OF THE INVENTION

Exemplary embodiments of the invention utilize an existing current sense output in the power switch to output fault diagnosis information. Current sense circuitry that normally drives the current sense output can be disabled to permit outputting the fault diagnosis information. An existing fault indicator output can be controlled for bidirectional operation, thereby permitting an external controller to control the output of fault diagnosis information on the existing current sense output.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; and the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 diagrammatically illustrates a power switch apparatus according to exemplary embodiments of the invention;

FIG. 2 is a timing diagram which illustrates an exemplary diagnostic interrogation sequence which can be performed by the apparatus of FIG. 1;

FIG. 3 illustrates exemplary operations which can be performed by the power switch apparatus and controller of FIG. 1; and

FIGS. 4-6 illustrate in tabular format various detailed examples of the diagnostic interrogation sequence illustrated in FIG. 2.

### DETAILED DESCRIPTION OF THE INVENTION

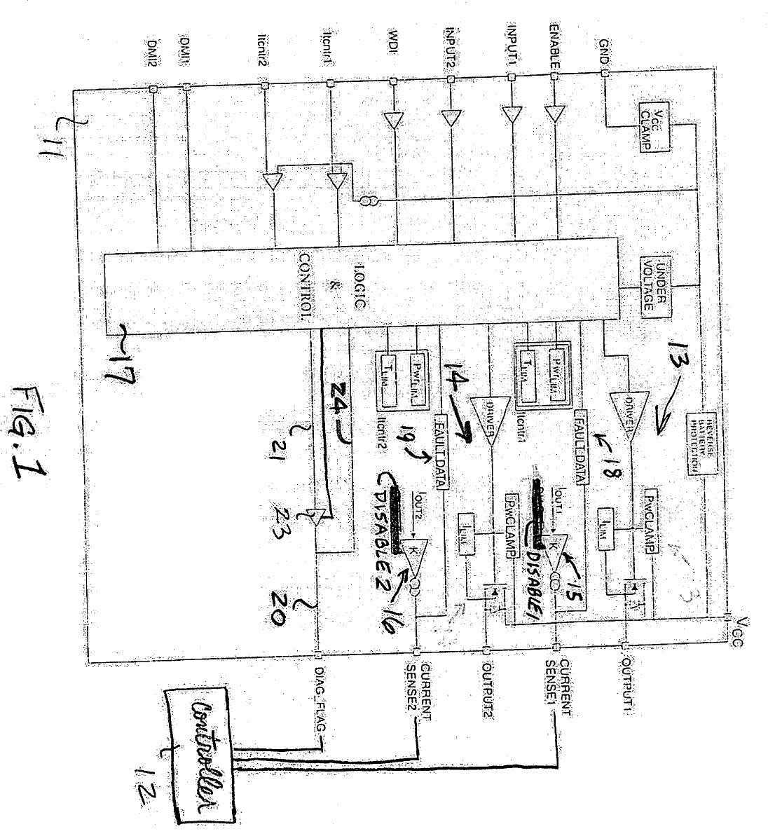

FIG. 1 diagrammatically illustrates a power switch apparatus according to exemplary embodiments of the invention. As shown in FIG. 1, the apparatus 11 is connected to a controller 12 (for example a microcontroller or microprocessor), in order to provide fault diagnosis information to the controller 12. The power switch includes switching circuitry 13 and 14 for selectively coupling the power supply input VCC to respective drive outputs designated as output1 and output2 in FIG. 1. The switching circuitry at 13 and 14 is controlled by control logic 17 in response to inputs designated as input1 and input2. In response to activation of input1, the control logic 17 causes switching circuitry 13 to switch drive current from VCC to output1. Similarly, in response to activation of input2, the control logic 17 causes switching circuitry 14 to switch drive current from VCC to output2. The current provided at output1 and output2 drives associated loads (not explicitly shown in FIG. 1). The switching circuitry at 13 and 14 can be any suitable conventional power switching circuitry, as well known to workers in the art.

The power switch 11 of FIG. 1 also includes current sense circuitry at 15 and 16. The current sense circuitry at 15 and 16 provide current sense outputs designated generally as current sense1 and current sense2, respectively. The output signal (e.g., a voltage) at current sense1 is proportional to the load current Iₒᵤₜ₁ provided at output1, and the output signal provided at current sense2 is proportional to the load current Iₒᵤₜ₂ provided at output2. The current sense circuitry at 15 and 16 is coupled to the switching circuitry at 13 and 14, respectively, in order to permit the current sense circuitry to sense the load currents and provide the load current-proportional outputs at current sense1 and current sense2. The use of such current sensing circuitry and load current-proportional outputs is well known in the art.

According to the present invention, the control logic 17 can produce signals designated as DISABLE1 and DISABLE2, which can respectively disable the current sense circuitry 15 and 16 from driving their respective current sense outputs. The control logic 17 can then use the current sense1 and current sense2 outputs for outputting fault diagnosis information as designated generally at 18 and 19. In order to coordinate the transfer of fault diagnosis information from the power driver apparatus 11 to the controller 12, in some embodiments, the power switch apparatus 11 includes a diagnostic flag (DIAG_FLAG) terminal 20 which the control logic 17 can selectively configure as either an input terminal or an output terminal. Exemplary embodiments implement this bidirectional terminal by providing a tri-state buffer/driver 23 between the control logic output 21 and the terminal 20. When the control logic 17 wishes to output information on the terminal 20, the control logic 17 enables the buffer 23 and provides the information at 21 for output through the buffer/driver 23 to the terminal 20. On the other hand, the control logic 17 can configure the terminal 20 as an input terminal by simply disabling (tri-stating) the buffer/driver 23, and then observing input signaling received at the terminal 20.

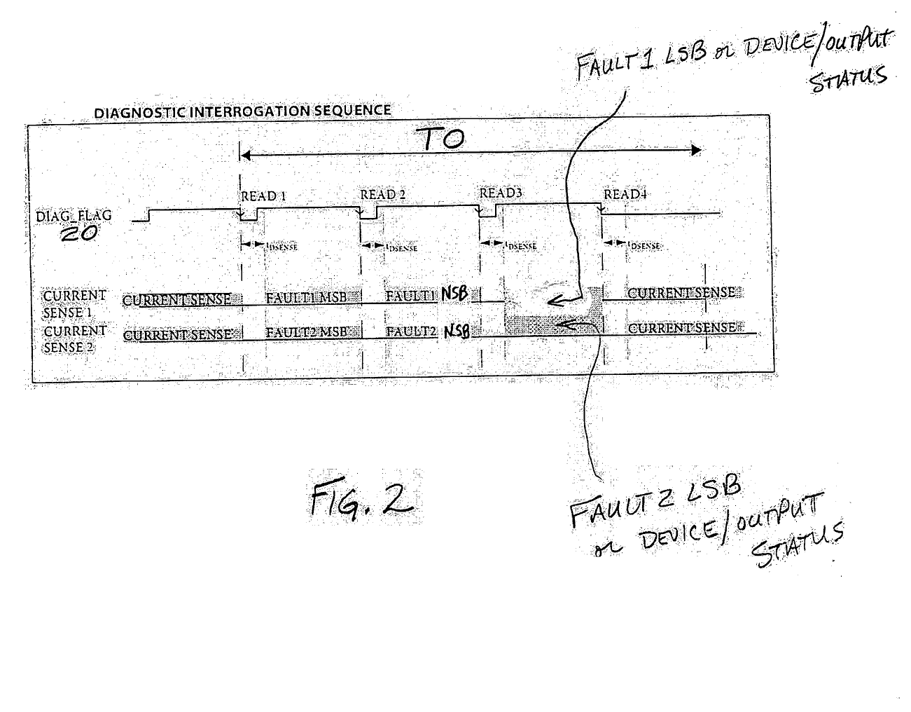

FIG. 2 is a timing diagram which illustrates exemplary operations that can be performed according to exemplary embodiments of the invention, for example, by the power switch apparatus 11 and controller 12 of FIG. 1. More particularly, FIG. 2 illustrates a diagnostic interrogation sequence wherein the power switch 11 provides fault diagnostic information to the controller 12. FIG. 2 illustrates the signal activity on the current sense1 and current sense2 outputs, as well as on the diagnostic flag terminal 20. As shown in FIG. 2, when the control logic 17 of FIG. 1 detects a fault condition, it drives the diagnostic flag terminal 20 to a high logic level. At this time, the current sense outputs are both still outputting signals that are proportional to the respective load currents at output1 and output2. This is designated by the “current sense” label in FIG. 2.

After the control logic 17 drives the diagnostic flag terminal 20 high, it can thereafter disable the buffer/driver 23 (see also FIG. 1), thereby permitting the controller 12 to drive the terminal 20 as an input to the power switch 11. The controller 12 then operates the diagnostic flag terminal 20 as a clock input to the power switch 11, thereby synchronizing the output of fault diagnostic information on the current sense outputs. As shown in FIG. 2, the controller 12 drives the diagnostic flag terminal 20 with a sequence of clock pulses, each having a length of t_{DSENSE} as shown in FIG. 2.

The control logic 17 responds to the first (read 1) clock pulse from the controller to provide on each of the current sense outputs (see also 18 and 19 in FIG. 1) the most significant bit (MSB) of a corresponding fault diagnostic code. In response to the next clock pulse (read 2) received from the controller, the control logic 17 provides on each of the current sense outputs the least significant bit (LSB) of the corresponding fault diagnostic code. After the third clock pulse (read 3) from the controller 12, the control logic 17 can provide on the current sense outputs information which indicates any other desired fault diagnostic condition, or alternatively, as illustrated specifically in FIG. 2, information which indicates that the power switch 11 has entered into a predefined fault mode of operation. When the controller 12 drives the terminal 20 low the next time following the “read 3” clock pulse, the control logic 17 deactivates the DISABLE1 and DISABLE2 signals, thereby permitting the current sense circuitry at 15 and 16 (see also FIG. 1) to resume normal operations.

Some embodiments utilize a timeout period of time, designated generally as TO in FIG. 2, to ensure that the diagnostic interrogation sequence is executed properly. In such embodiments, if the entire interrogation sequence, beginning with the “read 1” clock pulse and ending with a return to the normal current sense operation, is not completed within the time period designated at TO, then the diagnostic interrogation sequence can be reset. If such a timeout reset occurs, the control logic 17 will consider the next active low read clock pulse received from the controller 12 to be a “read 1” clock pulse.

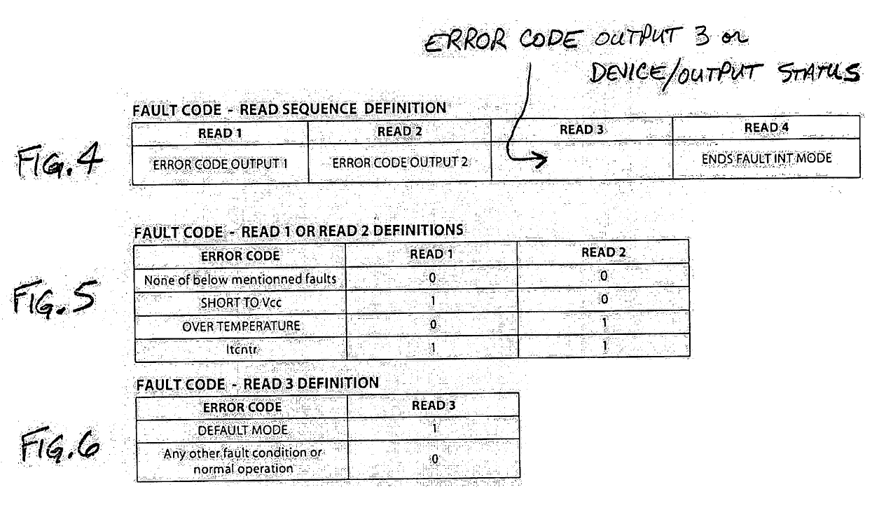

FIGS. 4, 5 and 6 illustrate in more detail various types of information which can be output from the control logic 17 of the power switch 11 to the controller 12 during the diagnostic interrogation sequence. As can be seen from FIGS. 2, 4 and 5, each of the current sense outputs can be utilized during the “read 1” and “read 2” time periods to output to the controller 12 any one of four possible fault diagnostic codes. In some embodiments, the fault diagnostic codes can designate short circuit or other overcurrent conditions, excessive temperature conditions, etc. As can also be seen from FIG. 5, one of the four available codes (00 in FIG. 5) can be used simply to indicate that none of the other three coded faults have been detected. As shown in FIG. 6, some embodiments use the “read 3” time period to indicate either that the default mode has been entered, or that another fault condition exists. Still further embodiments utilize the “read 3” time period to indicate either that the default mode has been entered or that normal operation is in effect.

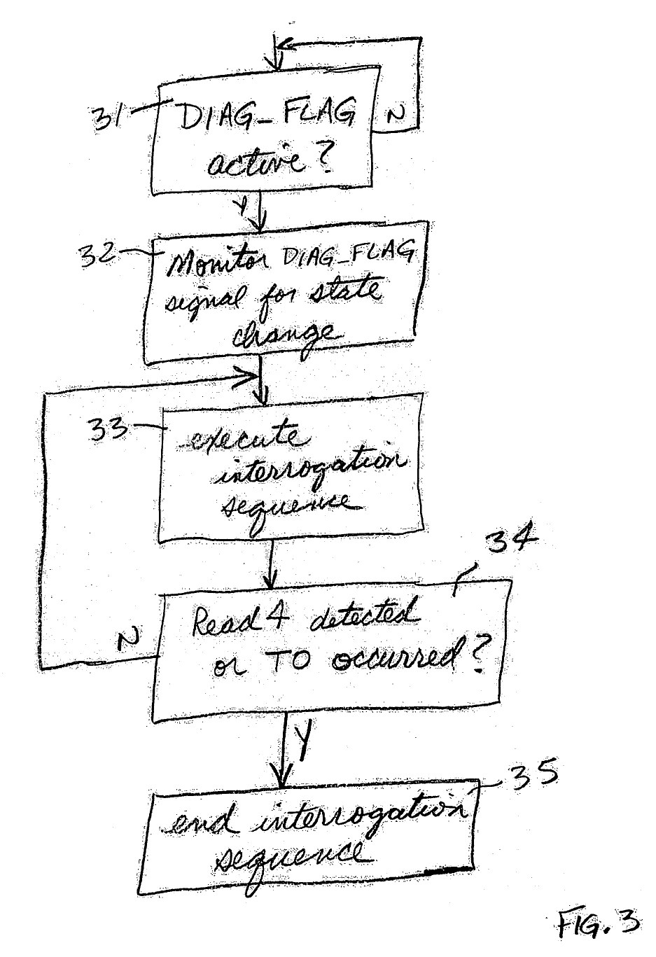

FIG. 3 illustrates exemplary operations which can be performed according to exemplary embodiments of the invention. Operations illustrated in FIG. 3 can be performed by the power switch apparatus 11 of FIG. 1, and also by the controller 12 of FIG. 1. At 31, it is determined whether the diagnostic flag as has been activated as an output at the terminal 20 (see also FIG. 1). If so, then the diagnostic flag terminal 20 is configured as an input at 32. Thereafter at 33, a diagnostic interrogation sequence is executed, for example a diagnostic interrogation sequence such as illustrated in FIG. 2. The operations at 31, 32 and 33 can be performed by a power switch apparatus according to the invention, for example the power switch apparatus 11 of FIG. 1. As illustrated by broken line in FIG. 3, the operations at 31 and 33 can be performed by an external controller that operates with a power switch apparatus according to exemplary embodiments of the invention, for example the external controller 12 of FIG. 1.

Although the present invention has been described in detail, those skilled in the art will understand that various changes, substitutions and alterations herein may be made without departing from the spirit and scope of the invention it its broadest form.

What is claimed is:

1. A power switching apparatus, comprising:
a power input for coupling to a source of current;
a drive output for coupling to a load;
a switching circuit coupled to said power input and said drive output for selectively coupling said drive output to said power input;
a current sense output;
a current sense circuit coupled to said switching circuit and said current sense output for providing at said current sense output a current sense signal that is indicative of a load current delivered to the load via said switching circuit, said current sense circuit having a disable input which, when activated, disables said current sense circuit from providing said current sense signal at said current sense output; and
logic coupled to said disable input and said current sense output, said logic responsive to a predetermined condition for activating said disable input and outputting on said current sense output information indicative of said predetermined condition.

2. The apparatus of claim 1, including a control terminal for receiving a control signal, said logic coupled to said control terminal and responsive thereto for outputting said information in response to said control signal.

3. The apparatus of claim 2, wherein said control signal is a periodic signal, and said logic provides said information as serial data synchronized with said periodic control signal.

4. The apparatus of claim 2, wherein said logic is responsive to said predetermined condition for outputting on said control terminal a signal that prompts an external source to provide said control signal.

5. The apparatus of claim 4, wherein said logic is capable of producing a plurality of digital codes which respectively correspond to a plurality of predetermined conditions, said information including one of said digital codes.

6. The apparatus of claim 5, wherein said logic outputs said one digital code as a serial data transmission.

7. The apparatus of claim 4, wherein said predetermined condition includes one of an overcurrent condition and an excessive temperature condition.

8. The apparatus of claim 1, wherein said logic is capable of producing a plurality of digital codes which respectively correspond to a plurality of predetermined conditions, said information including one of said digital codes.

9. The apparatus of claim 8, wherein said logic outputs said one digital code as a serial data transmission.

10. The apparatus of claim 1, wherein said predetermined condition includes one of an overcurrent condition and an excessive temperature condition.

11. A method of operating a power switching apparatus that includes a power input for coupling to a source of current, a drive output for coupling to a load, a switching circuit coupled to the power input and the drive output for selectively coupling the drive output to the power input, a current sense output, and a current sense circuit coupled to the switching circuit and the current sense output for providing at the current sense output a current sense signal that is indicative of a load current delivered to the load via the switching circuit, the method comprising:
in response to a predetermined condition, disabling the current sense circuit from providing the current sense signal at the current sense output; and
after said disabling step, outputting on the current sense output information indicative of the predetermined condition.

12. The method of claim 11, including receiving a control signal, and outputting said information in response to the control signal.

13. The method of claim 12, wherein the control signal is a periodic signal, and said outputting step including providing said information as serial data synchronized with said periodic control signal.

14. The method of claim 12, including outputting a signal that prompts an external source to provide said control signal.

15. The method of claim 14, wherein said information includes one of a plurality of digital codes which respectively correspond to a plurality of predetermined conditions.

16. The method of claim 15, wherein said outputting step includes outputting said one digital code as a serial data transmission.

17. The method of claim 14, wherein said predetermined condition includes one of an overcurrent condition and an excessive temperature condition.

18. The method of claim 11, said information includes one of a plurality of digital codes which respectively correspond to a plurality of predetermined conditions.

19. The method of claim 18, wherein said outputting step includes outputting said one digital code as a serial data transmission.

20. The method of claim 11, wherein said predetermined condition includes one of an overcurrent condition and an excessive temperature condition.
